(19) United States
(12) Patent Application Publication
(10) Pub. No.: US 2021/0350468 A1
(43) Pub. Date: Nov. 11, 2021

(54) NETWORK GRAPH OUTLIER DETECTION FOR IDENTIFYING SUSPICIOUS BEHAVIOR

(71) Applicant: STATE FARM MUTUAL AUTOMOBILE INSURANCE COMPANY, BLOOMINGTON, IL (US)

(72) Inventor: Stephen R. Prevatt, Normal, IL (US)

(73) Assignee: STATE FARM MUTUAL AUTOMOBILE INSURANCE COMPANY, BLOOMINGTON, IL (US)

(21) Appl. No.: 15/196,960

(22) Filed: Jun. 29, 2016

Related U.S. Application Data
(60) Provisional application No. 62/238,987, filed on Oct. 8, 2015.

(51) Int. Cl. G06Q 40/08; G06F 19/00

(52) U.S. Cl. CPC G06Q 40/08; G06F 19/328

(57) ABSTRACT

A computer-implemented method for detecting suspicious or fraudulent insurance claim filings may include receiving a list of individuals who file insurance claims; receiving a list of contacts for each individual; receiving information regarding relationships between the contacts; forming a plurality of ego networks that each include a central hub, a plurality of nodes, and a plurality of edges; determining a number of nodes for each ego network; determining a number edges for each ego network; forming a plurality of data points from the numbers of nodes and the numbers of edges; and calculating a distance of each data point from a predetermined normal relationship function to facilitate identifying outliers that warrant investigation or may be associated with insurance claim buildup.

### CROSS-REFERENCE TO RELATED APPLICATIONS

This application claims the benefit of priority of U.S. Provisional Patent Application Ser. No. 62/238,987, filed Oct. 8, 2015, the contents of which are hereby incorporated by reference, in their entirety and for all purposes, herein.

### FIELD OF THE INVENTION

The present disclosure generally relates to computing devices, computer-readable media, and computer-implemented methods that utilize network graph outlier detection techniques to identify outlier behavior.

### BACKGROUND

The insurance industry experiences many suspicious and potentially fraudulent claims. For example, a large number of people may file claims for injuries received in an automobile accident reported to have occurred at low speed and with little damage to the vehicles involved. Alternatively, a medical practice or facility may file claims seeking reimbursement for redundant or unnecessary tests, such as an X-ray, an ultrasound, and a CAT scan, for the same ailment of a single patient. Since an insurance company often receives thousands of filed claims per day, it may be difficult to identify individual occurrences of suspicious or fraudulent activity.

### BRIEF SUMMARY

Embodiments of the present technology relate to, inter alia, computing devices, computer-readable media, and computer-implemented methods for detecting outlier behavior, in general, and identifying suspicious or fraudulent insurance claim filings in one embodiment. For instance, the technology may create an ego network for each individual that may potentially be associated with insurance claim buildup, or otherwise suspected of filing fraudulent insurance claims. Each ego network may include a plurality of nodes and edges, which correspond to contacts of the individual and relationships there between. Ego networks for other individuals may be created as well. The numbers of nodes and edges for each ego network may create a two-dimensional data point. A distance from a normal relationship function may be calculated for each data point. The data points whose distance is greater than a predetermined threshold may be considered outliers and the individuals associated with the data points may be reported for further investigation.

In a first aspect, a computer-implemented method for detecting suspicious or fraudulent insurance claim filings may be provided. The method may include: (1) receiving a list of individuals who file insurance claims; (2) receiving a list of contacts for each individual; (3) receiving information regarding relationships between the contacts, such as contacts within a work or social network; (4) forming a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outliers or suspicious behavior. The method may include additional, fewer, or alternative actions, including those discussed elsewhere herein.

In another aspect, a computer-readable medium for detecting suspicious or fraudulent insurance claim filings may be provided. The computer-readable medium may include an executable program stored thereon, wherein the program may instruct a processing element of a network computing device to perform the following actions: (1) receiving a list of individuals who file insurance claims; (2) receiving a list of contacts for each individual; (3) receiving information regarding relationships between the contacts; (4) forming a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outlier behavior. The program stored on the computer-readable medium may instruct the processing element to perform additional, fewer, or alternative actions, including those discussed elsewhere herein.

In yet another aspect, a computing device for detecting suspicious or fraudulent insurance claim filings may be provided. The computing device may include a memory element and a processing element. The memory element may store computer data and executable instructions. The processing element may be electronically coupled to the memory element. The processing element may be configured to receive a list of individuals who file insurance claims; receive a list of contacts for each individual; receive information regarding relationships between the contacts; form a plurality of ego networks, each ego network including a central hub, a plurality of nodes, and a plurality of edges; determine a number of nodes for each ego network; determine a number edges for each ego network; form a plurality of data points from the numbers of nodes and the numbers of edges; and/or calculate a distance of each data point from a predetermined normal relationship function to facilitate outlier detection. The network computing device may include additional, fewer, or alternate components and/or functionality, including that discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of computing devices, computer-readable media, and computer-implemented methods disclosed therein. It should be understood that each Figure depicts an embodiment of a particular aspect of the disclosed devices, media, and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates various components, in block schematic form, of an exemplary computing device configured to generally identify outliers or detect suspicious behavior, and more specifically identify potential buildup in one embodiment;

FIG. 2 illustrates an ego network of an individual suspected of potentially fraudulent activity, the ego network including a plurality of nodes and a plurality of edges;

FIG. 3 illustrates a plot of the number of edges versus a number of nodes for a plurality of ego networks; and

FIGS. 4A and 4B illustrate a flow diagram of at least a portion of the steps of an exemplary method for generally identifying outliers, and more specifically for detecting suspicious or fraudulent insurance claim filings in one embodiment.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments described in this patent application and other possible embodiments address a computer-centric challenge or problem with a solution that is necessarily rooted in computer technology and may relate to, inter alia, computing devices, software applications, methods, and media for identifying outlier behavior, such as detecting suspicious or fraudulent insurance claim filings. Examples of the activity may include filing medical insurance claims for seemingly redundant or unnecessary tests, such as an X-ray, an ultrasound, and a CAT scan, for the same ailment of a single patient. Or, a number of people may file medical insurance claims resulting from an automobile accident reported to have occurred at low speed with little or no damage to the vehicles involved. Often, the activity is repeated or ongoing. The present embodiments may be utilized when suspicions are aroused from various sources, such as an accounting or claims group at an insurance provider, regarding the activity of certain individuals or groups. The present embodiments may also be implemented as part of a periodic or random investigation process, or as part of a standard operating procedure.

The present embodiments may include a method with at least the steps of receiving a list of individuals who may potentially be, or are even suspected to be, involved in filing fraudulent insurance claims or otherwise associated with insurance claim buildup, and receiving information about the contacts of each individual. The contacts generally include persons with which the individual has had a professional or business relationship. The relationships of the contacts with one another may also be received. A plurality of ego networks may be formed—one for each individual, with each ego network including a central hub representing one individual, a plurality of nodes representing contacts of the individual, and a plurality of edges or links between nodes and the hub representing the relationships between contacts and the individual.

For each ego network, a number of nodes may be determined, with each contact that the individual has being counted as a node. Also, a number of edges may be determined, with each relationship between the individual and the contacts, as well as each relationship between contacts, being counted as an edge. A plurality of data points may be formed, wherein each data point includes the number of nodes as an X-value and the number of edges as a Y-value, from one ego network. A relationship between the nodes and the edges indicating normal, non-suspicious behavior may already be known or determined. A distance measuring technique may be applied to the data set to determine a distance from the normal relationship of each data point. The data points which have a distance greater than a predetermined threshold may be considered “outliers” and may be flagged for further review.

### Exemplary Computing Device

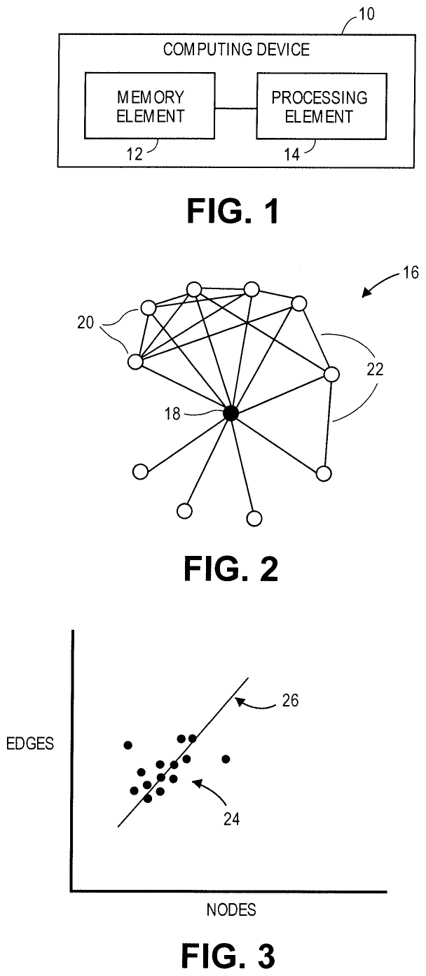

FIG. 1 depicts at least a portion of the components of a computing device 10 configured to detect suspicious or fraudulent insurance claim filings. The computing device 10 may be embodied by a server computer, a workstation computer, a desktop computer, a laptop computer, a tablet computer, or the like. The computing device 10 may include a memory element 12 and a processing element 14. The computing device 10 may further include a display, input devices such as a keyboard and mouse, communication elements to transmit and receive wired or wireless communication, and the like.

The memory element 12 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. The memory element 12 may include, or may constitute, a “computer-readable medium”. The memory element 12 may store the instructions, code, code segments, software, firmware, programs, applications, apps, services, daemons, or the like that are executed by the processing element 14. The memory element 12 may also store settings, data, documents, sound files, photographs, movies, images, databases, and the like.

The processing element 14 may include processors, microprocessors (single-core and multi-core), microcontrollers, DSPs, field-programmable gate arrays (FPGAs), analog and/or digital application-specific integrated circuits (ASICs), or the like, or combinations thereof. The processing element 14 may generally execute, process, or run instructions, code, code segments, software, firmware, programs, applications, apps, processes, services, daemons, or the like. The processing element 14 may also include hardware components such as finite-state machines, sequential and combinational logic, and other electronic circuits that can perform the functions necessary for the operation of embodiments of the current invention. The processing element 14 may be in communication with the other electronic components through serial or parallel links that include address busses, data busses, control lines, and the like.

Through hardware, software, firmware, or various combinations thereof, the processing element 14 may be configured or programmed to perform the following operations. The computing device 10 may receive a list of names of individuals who file insurance claims and are suspected to be involved in potentially fraudulent activity. The list may be stored in the memory element 12 and may also include names of individuals who insurance claims and are in the same field or profession as the suspected individuals, but who are not necessarily suspected of fraud. As an example, the individuals may be medical providers, such as doctors. In some cases, the individuals may include only those in a particular specialty, such as chiropractors. The number of individuals may range from in the dozens to in the thousands. In some embodiments, the list may include a plurality of identification (ID) numbers or codes, instead of actual names of the individuals involved.

The computing device 10 may further receive a list of contacts of each individual. The contacts generally include others with whom the individual has had a professional or business relationship, such as those who have either provided a service to, or received a service from, the individual, or those who have either purchased goods from, or sold goods to, the individual. The contacts may further include employment superiors, subordinates, or co-workers. In some embodiments, the contacts may include a plurality of IDs instead of names.

The computing device 10 may also receive information or a list regarding the relationships between the contacts themselves. For example, the computing device 10 may receive an indication that two or more contacts of one individual have professional or business relationships independent from the individual. Information regarding the contacts and the relationships may be stored in the memory element 12.

The processing element 14 may form a plurality of ego networks 16, one ego network 16 for each individual. Each ego network 16 may include a central hub 18 representing one individual, a plurality of nodes 20 representing contacts of the individual, and a plurality of edges 22 or links between nodes 20 and the central hub 18 representing the relationships between contacts and the individual. A visualization of one ego network 16 is shown in FIG. 2.

For each ego network 16, the processing element 14 may determine a number of nodes 20, seen as open circles in FIG. 2, with each contact that the individual has being counted as one node 20. The processing element 14 may also determine a number of edges 22, seen as lines in FIG. 2, with each relationship/line between the individual and the contacts as well as each relationship/line between contacts being counted as one edge 22. The processing element 14 may then form a plurality of data points 24, wherein each data point 24 includes the number of nodes 20, as an X-value, and the number of edges 22, as a Y-value, from one ego network 16. A plot of fourteen sample data points 24, derived from fourteen ego networks 16, is shown in FIG. 3.

A normal relationship function 26 between the nodes 20 and the edges 22 indicating normal, non-suspicious behavior may be known before the currently-discussed operation of the processing element 14 takes place. The normal relationship function 26 between the nodes 20 and edges 22 may take the form of a mathematical function, such as a linear function, a power function, an exponential function, or the like. An example of a linear function may include the following equation: edges=1.8×nodes+10. The normal relationship function 26 may be determined by acquiring a large set of data points 24 of nodes 20 and edges 22 representing individuals who are known to always engage in legal behavior, such as always filing legitimate insurance claims. Then, the function is developed by applying a fitting process, such as curve fitting, linear regression, convolutional neural networks, or the like, to the data points 24. An exemplary linear normal relationship function 26 between the nodes 20 and the edges 22 is shown as the straight line in FIG. 3.

The processing element 14 may determine how far out of the norm is each data point. One approach is for the processing element 14 to determine the linear distance of each data point from the normal relationship function 26. Those data points 24 whose linear distance is greater than a certain threshold may be determined to be outliers from the norm. The processing element 14 may display the names or ID numbers of those individuals whose ego network 16 was associated with a data point found to be an outlier. The individuals may then be investigated further to determine whether fraudulent activity or buildup has occurred.

### Exemplary Computer-Implemented Method

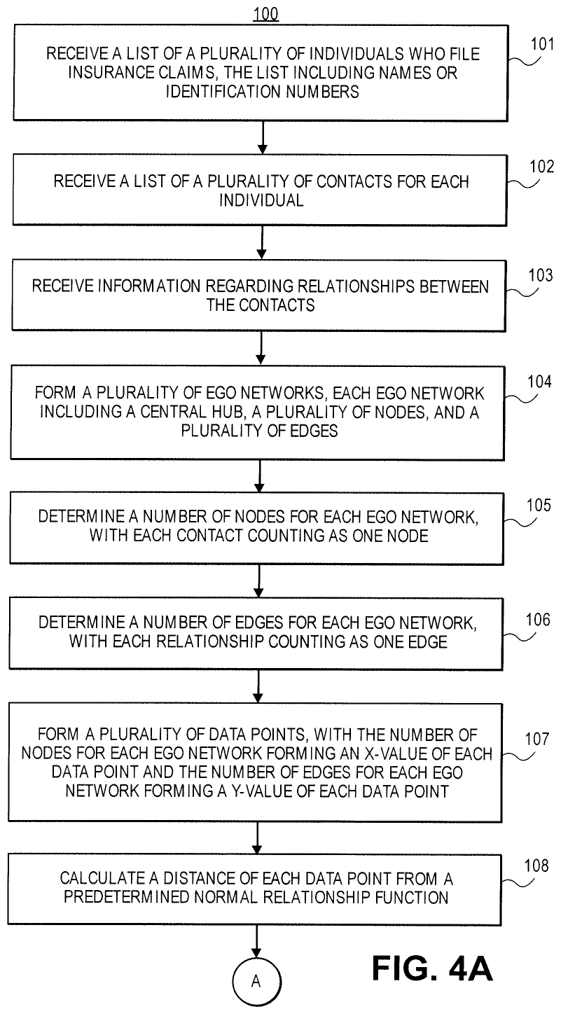

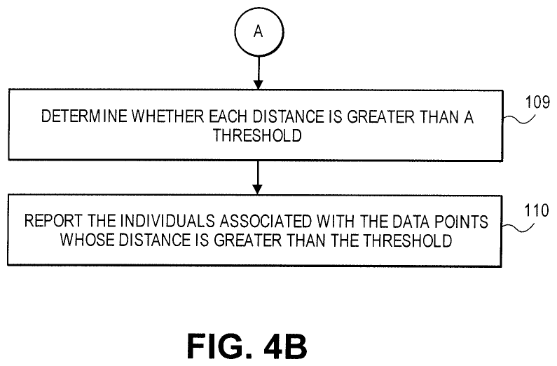

FIG. 4 depicts a listing of steps of an exemplary computer-implemented method 100 for detecting suspicious or fraudulent insurance claim filings. The steps may be performed in the order shown in FIG. 4, or they may be performed in a different order. Furthermore, some steps may be performed concurrently as opposed to sequentially. In addition, some steps may be optional. The steps of the computer-implemented method 100 may be performed by the computing device 10.

Referring to step 101, a list of individuals who file insurance claims may be received and/or determined. The list may include names of individuals or it may include identification numbers or codes. The list may include individuals who may be, or are suspected of being, involved in fraudulent insurance claim filings, as well as individuals who are in the same field or profession but are not necessarily suspected of wrongdoing. As an example, the individuals may be medical providers, such as doctors. In some cases, the individuals may include only those in a particular specialty, such as chiropractors. The number of individuals may range from in the dozens to in the thousands.

Referring to step 102, a list of contacts for each individual may be received and/or determined. The contacts generally include others with whom the individual has had a professional or business relationship, such as those who have either provided a service to, or received a service from, the individual, or those who have either purchased goods from, or sold goods to, the individual. The contacts may further include employment superiors, subordinates, or co-workers. In some embodiments, the contacts may include a plurality of IDs instead of names.

Referring to step 103, information regarding relationships between the contacts may be received and/or determined. For example, the computing device 10 may receive an indication that two or more contacts of one individual have professional or business relationships independent from the individual.

Referring to step 104, a plurality of ego networks 16 may be formed or generated. Each ego network 16 may include a central hub 1A representing one individual, a plurality of nodes 20 representing contacts of the individual, and a plurality of edges 22 or links between nodes 20 and the hub 1A representing the relationships between contacts and the individual. A visualization of one ego network 16 is shown in FIG. 2.

Referring to step 105, a number of nodes 20 for each ego network 16 may be determined. Each contact that the individual has is counted as one node 20. The nodes 20 of the ego network 16 are seen as open circles in FIG. 2.

Referring to step 106, a number of edges 22 for each ego network 16 may be determined. Each relationship between the contacts, and between the contacts and the individual, is counted as one edge 22. The edges 22 of the ego network 16 are seen as lines in FIG. 2.

Referring to step 107, a plurality of data points 24 may be formed or generated. Each data point 24 may include the number of nodes 20, as an X-value, and the number of edges 22, as a Y-value, from one ego network 16. A plot of fourteen sample data points 24, derived from fourteen ego networks 16, is shown in FIG. 3.

Referring to step 108, a distance from each data point to a predetermined normal relationship function 26 may be calculated. The normal relationship function 26 between the nodes 20 and edges 22 may indicate normal, non-suspicious behavior and may take the form of a mathematical function, such as a linear function, a power function, an exponential function, or the like. An example of a linear function may include the following equation: edges=1.8×nodes+10. The normal relationship function 26 may be determined by acquiring a large set of data points 24 of nodes 20 and edges 22 representing individuals who are known to always engage in legal behavior, such as always filing legitimate insurance claims. Then, the function may be developed by applying a fitting process, such as curve fitting, linear regression, convolutional neural networks, or the like, to the data points 24. An exemplary linear normal relationship function 26 between the nodes 20 and the edges 22 is shown as the straight line in FIG. 3. The distance from each data point to the normal relationship function 26 may be calculated as the linear distance.

Referring to steps 109 and 110, it may be determined whether the distance from each data point to the normal relationship function 26 is greater than a threshold. Those data points 24 whose linear distance is greater than the threshold may be determined to be outliers from the norm. The names or ID numbers of those individuals whose ego network 16 was associated with a data point found to be outliers may be reported or displayed on a screen. The individuals may then be investigated further to determine whether fraudulent activity has occurred.

### Exemplary Method for Detecting Buildup

In a first aspect, a computer-implemented method for detecting buildup, and/or suspicious or fraudulent insurance claim filings, may be provided. The method may include: (1) receiving a list of individuals who file insurance claims; (2) receiving a list of contacts for each individual; (3) receiving information regarding relationships between the contacts; (4) forming a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outliers. The method may include additional, fewer, or alternative actions, including those discussed elsewhere herein.

For instance, the method may include: determining whether the distance of each data point is greater than a threshold; and/or reporting the individuals associated with the data points whose distance is greater than the threshold. In addition, determining the number of nodes for each ego network may include counting each contact as one node; determining the number of edges for each ego network may include counting each relationship between the individual and one contact as one edge and each relationship between two contacts as one edge; and each data point may include the number of nodes from one ego network as an X-value, and the number of edges from the same ego network as a Y-value.

### Exemplary Computer-Readable Medium for Detecting Buildup

In another aspect, a computer-readable medium for detecting buildup, and/or suspicious or fraudulent insurance claim filings may be provided. The computer-readable medium may include an executable program stored thereon, wherein the program instructs a processing element of a network computing device to perform the following steps: (1) receiving a list of individuals who file insurance claims; (2) receiving a list of contacts for each individual; (3) receiving information regarding relationships between the contacts; (4) forming a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outliers. The program stored on the computer-readable medium may instruct the processing element to perform additional, fewer, or alternative actions, including those discussed elsewhere herein.

For instance, the program may instruct the processing element to: determine whether the distance of each data point is greater than a threshold; and/or report the individuals associated with the data points whose distance is greater than the threshold. In addition, determining the number of nodes for each ego network may include counting each contact as one node; determining the number of edges for each ego network may include counting each relationship between the individual and one contact as one edge, and each relationship between two contacts as one edge; and each data point may include the number of nodes from one ego network as an X-value and the number of edges from the same ego network as a Y-value.

### Exemplary Computing Device for Detecting Buildup

In yet another aspect, a computing device for detecting buildup, and/or suspicious or fraudulent insurance claim filings may be provided. The computing device may include a memory element and a processing element. The memory element may store computer data and executable instructions. The processing element may be electronically coupled to the memory element. The processing element may be configured to receive a list of individuals who file insurance claims; receive a list of contacts for each individual; receive information regarding relationships between the contacts; form a plurality of ego networks, each ego network including a central hub, a plurality of nodes, and a plurality of edges; determine a number of nodes for each ego network; determine a number edges for each ego network; form a plurality of data points from the numbers of nodes and the numbers of edges; and/or calculate a distance of each data point from a predetermined normal relationship function to facilitate identifying outliers. The computing device may include additional, fewer, or alternate components and/or functionality, including that discussed elsewhere herein.

The processing element may be further configured to: determine whether the distance of each data point is greater than a threshold; and/or report the individuals associated with the data points whose distance is greater than the threshold. In addition, determining the number of nodes for each ego network may include counting each contact as one node; determining the number of edges for each ego network may include counting each relationship between the individual and one contact as one edge, and each relationship between two contacts as one edge; and each data point may include the number of nodes from one ego network as an X-value, and the number of edges from the same ego network as a Y-value.

### Exemplary Network Graph Topologies

With the present embodiments, network graph topologies may be used to detect anomalous behavior. Traditional statistical modeling datasets may be arranged so that each record in a table corresponds to an observation. For each observation, there may be a dependent attribute, or “target,” whose value is used to train or test the model. Network graphs may be defined so that each observation of the target attribute can correspond with one actor in the network graph. Small “ego networks” may then be created for each of these actors, and tractable statistics calculated that describes information from the network. Since there is a one-to-one correspondence between the observation targets from the traditional statistical modeling dataset and the actors on the network graph, information from the network graph may then be expressed in a fashion that is useful for traditional statistical modeling techniques which may be quite tractable.

In other words, ego network statistics may be used to directly augment data observations used for traditional statistical modeling analysis. The present embodiments may involve first creating a representation of the actors (nodes) and relationships (links) as a network graph (the links may be pointers or other data structures). The second step may include creating metrics based upon ego networks for each actor. The metrics and/or the derived attributes generated from the second step may be used as dependent variables in the observational dataset used for a traditional statistical regression model. Examples of ego network metrics may include density, degree, total link count, total node count, ego betweeness, number of components, number of isolates, ego closeness, Eigenvector values, and/or Bonachich values.

In one respect, the present embodiments may be used to detect fraud or potentially bad actors. The working and/or social network of an individual may be virtually represented as a central node or hub (representing the individual) with spoke to other nodes (representing contacts, such as colleagues or co-workers, or service providers). Pattern recognition techniques may be used to identify activity that has occurred before and that looks suspicious. For instance, certain causes of losses for certain types of insurance claims (such as with wildfire or fire claims or auto claims) may be associated with a higher than normal degree of inflated insurance claims. Virtual models or patterns (and/or attributes or characteristics) may be built (or identified) corresponding to this type of questionable activity, and those virtual models or patterns used by a processor to identify outlier activity or behavior that warrants further investigation.

As an example, a medical provider (such as a doctor or clinic) may be one actor and have a virtual central node or hub representing it. Data fields associated with the medical provider may include an insurance claim number, a cause of loss, a treatment code, a treatment prescribed, and/or a radiologist or blood lab that provided services to the patient. Other data may include a number of claims submitted per day or week by the medical provider, and/or number of billings per day by the medical provider. A large number of insurance claims and/or a large number of a specific type of insurance claim may warrant investigation.

In one embodiment, historical claims data may be analyzed, common attributes of fraudulent claims identified, and then a processor may analyze newly submitted claims for those common attributes associated with fraud. For instance, level of physical damage to a vehicle versus number of injured passengers, type of injuries, number of ambulances involved, and/or time of day of loss or vehicle collision, may be attributes or factors analyzed.

Further data may relate to types of drugs or medications prescribed, and/or the frequency thereof. Such information may be analyzed to indicate inflated insurance claims. Also, by associating the medical provider with each service provider it used (such as the radiologist mentioned above, or another type of specialist, contractor, supplier), patterns may be identified that reveal a network of bad actors, such as certain medical providers and service providers working in tandem to inflate insurance claims or overbill for services. For instance, several bad actors may identified by a single or common cell phone number, or by primary contact.

An example actor may be a chiropractor. The nodes (or virtual work network) for this actor may reveal that the chiropractor works with 12 doctors, 3 radiologists, and 2 acupuncturists—each of whom may be virtually represented as a node linked (such as by a pointer) to a central hub or node representing the chiropractor. The several doctors may be viewed as a virtual sub-network, as well as the several radiologists and acupuncturists. Both the main virtual network and virtual sub-networks may be analyzed by a processor for outlier behavior and/or common attributes.

As another example, after a weather event, a large amount of damage may be incurred by homes. However, certain fly-by-night construction crews may overinflate claims for home damage, such as hail or wind damage caused to roofs. Bad actors may be identified by ownership or ownership entity, or by single cell phone number. Other inflated claims may relate to remodeling or water damage/loss.

### Additional Exemplary Computer-Implemented Methods

In one aspect, a computer-implemented method may be provided that detects outlier behavior in general, and in one embodiment, suspicious or fraudulent insurance claim filings. The computer-implemented method may include: (1) determining and/or receiving a list of individuals; (2) determining and/or receiving a list of contacts for each individual; (3) determining and/or receiving information regarding relationships between the contacts and/or the individuals; (4) forming or generating a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outliers. The individuals may be associated with insurance products or services (such as life, health, auto, home, personal articles, workers comp., pet, or other types of insurance), and/or financial products or services (such bank accounts, checking or savings accounts, mutual funds, stocks or bonds, or personal, auto, or home loans or loan products). Additionally or alternatively, the individuals may be associated with filing insurance claims (such as auto, home, health, life, or other types of insurance claims) and an abnormal distance calculated for a data point may be indicative of insurance claim buildup or potential buildup warranting further investigation. In other aspects, the individuals may be medical services providers that submit insurance claims on behalf of patients, or construction workers or companies that repair damaged insured homes.

In another aspect, a computer-implemented method may be provided that detects outlier behavior in general, and suspicious or fraudulent insurance claim filings in one embodiment. The computer-implemented method may include (1) determining and/or receiving a list of individuals; (2) determining and/or receiving a list of contacts for each individual; (3) determining and/or receiving information regarding relationships between the contacts and/or individuals; (4) forming or generating a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges, wherein each data point includes the number of nodes from one ego network as an X-value, and the number of edges from the same ego network as a Y-value; (8) calculating a distance of each data point from a predetermined normal relationship function; (9) determining whether the distance of each data point is greater than a threshold; and/or (10) reporting the individuals associated with the data points whose distance is greater than the threshold to facilitate identifying outliers. The individuals may be associated with insurance products or services (such as life, health, auto, home, personal articles, pet, or other types of insurance), and/or financial products or services (such bank accounts, checking or savings accounts, mutual funds, stocks or bonds, or personal, auto, or home loans or loan products). Additionally or alternatively, the individuals may be associated with filing insurance claims (such as auto, home, health, life, or other types of insurance claims) and an abnormal distance calculated for a data point (and/or an individual associated with a data point whose distance is greater than the threshold) may be indicative of insurance claim buildup or potential buildup warranting further investigation.

The foregoing methods may include additional, less, or alternate functionality, including that discussed elsewhere herein. The foregoing methods may be implemented via one or more local or remote processors, and/or via computer-executable instructions stored on non-transitory computer-readable media or medium.

### Additional Exemplary Computer-Readable Medium

In one aspect, a non-transitory computer-readable medium with an executable program stored thereon for detecting outlier behavior may be provided. In one embodiment, the program may detect suspicious or fraudulent insurance claim filings. The program may instruct a hardware processing element of a computing device to perform the following: (1) determining and/or receiving a list of individuals; (2) determining and/or receiving a list of contacts for each individual; (3) determining and/or receiving information regarding relationships between the contacts and/or individuals; (4) forming or generating a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges; and/or (8) calculating a distance of each data point from a predetermined normal relationship function to facilitate identifying outliers. The individuals may be associated with (such as buying, selling, using, etc.) insurance products or services, or financial products or services. Additionally or alternatively, the individuals may be associated with filing insurance claims and an abnormal distance calculated for a data point (and/or an individual associated with a data point whose distance is greater than the predetermined normal relationship) may be indicative of insurance claim buildup.

In another aspect, a non-transitory computer-readable medium with an executable program stored thereon for detecting outliers and/or suspicious or fraudulent insurance claim filings may be provided. The program may instruct a hardware processing element of a computing device to perform the following: (1) determining and/or receiving a list of individuals; (2) determining and/or receiving a list of contacts for each individual; (3) determining and/or receiving information regarding relationships between the contacts and/or individuals; (4) forming or generating a plurality of ego networks, each ego network including a central hub, a plurality of nodes, and a plurality of edges; (5) determining a number of nodes for each ego network; (6) determining a number edges for each ego network; (7) forming a plurality of data points from the numbers of nodes and the numbers of edges, wherein each data point includes the number of nodes from one ego network as an X-value and the number of edges from the same ego network as a Y-value; (8) calculating a distance of each data point from a predetermined normal relationship function; (9) determining whether the distance of each data point is greater than a threshold; and/or (10) reporting the individuals associated with the data points whose distance is greater than the threshold. The individuals may be associated with (such as buying, selling, using, etc.) insurance products or services, or financial products or services.

Additionally or alternatively, the individuals may be associated with filing insurance claims and an abnormal distance calculated for a data point (and/or an individual associated with a data point whose distance is greater than the predetermined threshold) may be indicative of insurance claim buildup. The foregoing computer-readable mediums may include additional, less, or alternate instructions, including those discussed elsewhere herein.

### Additional Computing Devices

In one aspect, a computing device may be provided that is configured for outlier detection in general, and for detecting suspicious or fraudulent insurance claim filings in one embodiment. The device may include (1) a non-transitory hardware memory element configured to store computer data and executable instructions; and (2) a hardware processing element electronically coupled to the memory element, the processing element configured to: (i) generate and/or receive a list of individuals; (ii) generate and/or receive a list of contacts for each individual; (iii) generate and/or receive information regarding relationships between the contacts and/or the individuals; (iv) form or generate a plurality of ego networks, each ego network including a central hub, a plurality of nodes, and a plurality of edges; (v) determine a number of nodes for each ego network; (vi) determine a number edges for each ego network; (vii) form a plurality of data points from the numbers of nodes and the numbers of edges; and/or (viii) calculate a distance of each data point from a predetermined normal relationship function to facilitate identifying outliers. The individuals may be associated with (such as buying, selling, using, etc.) insurance products or services, or financial products or services. Additionally or alternatively, the individuals may be associated with filing insurance claims and an abnormal distance calculated for a data point (and/or an individual associated with a data point whose distance is greater than the predetermined normal relationship) may be indicative of insurance claim buildup.

In another aspect, a computing device may be provided that is configured for automatic configuring of a network of interconnected data storage devices and data transmission devices to handle electronic data traffic. The device may include a non-transitory hardware memory element configured to store computer data and executable instructions; and a hardware processing element electronically coupled to the memory element, the processing element configured to: generate and/or receive a list of individuals who file insurance claims; generate and/or receive a list of contacts for each individual; generate and/or receive information regarding relationships between the contacts; form or generate a plurality of ego networks, each ego network including a central hub, a plurality of nodes, and a plurality of edges; determine a number of nodes for each ego network; determine a number edges for each ego network; form a plurality of data points from the numbers of nodes and the numbers of edges, wherein each data point includes the number of nodes from one ego network as an X-value, and the number of edges from the same ego network as a Y-value; calculate a distance of each data point from a predetermined normal relationship function; determine whether the distance of each data point is greater than a threshold; and/or report the individuals associated with the data points whose distance is greater than the threshold. The foregoing computing devices may include additional, less, or alternate functionality, including that discussed elsewhere herein.

### Additional Aspects

As mentioned above, additional attributes or metrics may be considered for outlier detection in general, and for detecting suspicious or fraudulent insurance claim filings in various embodiments. In continuing the example of detecting suspicious or fraudulent insurance claim filings from individual practitioners or groups of practitioners in the medical industry, additional attributes may include metrics such as a practice type, a size of the practice (as measured by the number of patients seen by the practice over a certain time period), a number of years that the practice has existed, and so forth. Table 1 includes a plurality of entries with some of these attributes and the values associated therewith.

TABLE 1

| | | | | Size of | Years |
|---|---|---|---|---|---|
| | | | | Practice | Practice |
| | | | | (# of | has |
| Observation # | Nodes | Edges | Practice Type | Patients) | Existed |
| 1 | 52 | 75 | General | 250 | 10 |
| 2 | 66 | 91 | General | 225 | 12 |
| 3 | 85 | 120 | General | 400 | 15 |
| 4 | 28 | 35 | Dermatology | 120 | 5 |

The observation number simply refers to a number of the individuals or groups who are under suspicion or who are in the same industry or profession as the individual under suspicion. The observation number may range from in the dozens to in the thousands. The numbers of nodes and edges may be derived from the number of nodes 20 and the number of edges 22 for the ego network 16, such as the one shown in FIG. 2, of each individual or group under suspicion. Table 1 may be further populated with the practice type, the practice size, and the practice age for each individual or group.

To determine outlier behavior of the individuals or groups based on the other metrics, any metric with a non-numeric value, such as text data, may be quantified. For example, each of the types of the practice type metric may be assigned a numeric value. From Table 1, the “general” type may be assigned a value of “1”, the “dermatology” type may be assigned a value of “2”, etc. The other metrics may include numeric values, such as number of patients, number of years, etc., may be either left alone, scaled, normalized, reassigned a value, or the like. Scaling of the metrics may involve multiplying the value of each entry by a scalar. Normalizing the metrics may involve dividing the value of each entry by the value of a selected entry. Reassigning a value to the metrics may involve comparing the value of each entry to a numeric constant and assigning a first value to the entry if its value is less than or equal to the numeric constant or assigning a second value to the entry if its value is greater than the numeric constant. Values in addition to the first and second values may also be assigned by comparing the value of each entry to each of several ranges of numeric constants and assigning a value to the entry based on the range of numeric constants in which the entry falls. The values at all of the entries for each metric may be considered data points 24, with the values of the first metric being a first set of data points 24, the values of the second metric being a second set of data points 24, and so forth.

After all of the metrics have a set of data points 24, either by default or by assignment, if it is known that the individuals or groups have not engaged in suspicious behavior, then the data points 24 may be forwarded to a computer learning system that incorporates curve fitting, neural networks, regression model builders, or the like to develop a model of normal behavior for each metric. The model for each metric may be similar to the normal relationship function 26, shown in FIG. 3 and discussed above, and may include an algebraic equation with a variable for the metric which is multiplied by a coefficient. Furthermore, each equation may involve variables from the ego network 16 such as nodes 20 or edges 22. The computer learning system may determine the coefficients of the variables.

Alternatively, if the data presented in Table 1 represents individuals or groups who are under suspicion, then analysis of the data points 24 in view of the normal behavior model, or the normal relationship function 26, may be performed. For example, the computing device 10 or one or more steps of the method 100 may determine how far out of the norm is each data point. One approach is to determine the linear distance of each data point from the normal relationship function 26. Those data points 24 whose distance is greater than a certain threshold may be determined to be outliers from the norm. The names or ID numbers of those individuals or groups whose ego network 16 was associated with a data point found to be an outlier may be displayed. The individuals or groups may then be investigated further to determine whether fraudulent activity or buildup has occurred.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for detecting outliers, the method comprising the following steps, wherein each step is performed by a processor of a computing device:
receiving, from a memory element, a list of individuals who file insurance claims;
receiving, from the memory element, a list of contacts for each individual;
receiving, from the memory element, information listing relationships between two or more of the contacts and between each contact and the individual;
forming a plurality of ego networks, one ego network formed for each individual with each ego network including a central hub representing the individual, a plurality of nodes with each node representing a contact, and a plurality of edges with each edge representing a relationship between one contact and the individual or between two contacts;
determining a number of nodes for each ego network;
determining a number of edges for each ego network;
forming a plurality of two-dimensional data points from the numbers of nodes and the numbers of edges, with each data point representing one ego network and the number of nodes of the ego network forming an x-coordinate of the data point and the number of edges of the ego network forming a y-coordinate of the data point;
developing, using a computer learning system, a mathematical function defining a normal relationship between edges and nodes for each ego network, wherein developing the mathematical function comprises applying curve fitting to the data points;
determining a distance of each data point from the mathematical function defining a normal relationship between edges and nodes for each ego network to facilitate identifying the outliers; and
displaying, on a display device, names or ID numbers of the outliers.

2. The computer-implemented method of claim 1, further comprising determining whether the distance of each data point is greater than a threshold.

3. The computer-implemented method of claim 2, further comprising reporting the individuals associated with the data points whose distance is greater than the threshold.

4. The computer-implemented method of claim 1, wherein determining the number of nodes for each ego network includes counting each contact as one node.

5. The computer-implemented method of claim 1, wherein determining the number of edges for each ego network includes counting each relationship between the individual and one contact as one edge and each relationship between two contacts as one edge.

6. (canceled)

7. The computer-implemented method of claim 1, wherein the mathematical function defining the normal relationship is a linear function.

8. A computer-implemented method for detecting outliers, the method comprising the following steps, wherein each step is performed by a processor of a computing device:
receiving, from a memory element, a list of individuals who file insurance claims;
receiving, from the memory element, a list of contacts for each individual;
receiving, from the memory element, information listing relationships between two or more of the contacts and between each contact and the individual;
forming a plurality of ego networks, one ego network formed for each individual with each ego network including a central hub representing the individual, a plurality of nodes with each node representing a contact, and a plurality of edges with each edge representing a relationship between one contact and the individual or between two contacts;
determining a number of nodes for each ego network;
determining a number of edges for each ego network;
forming a plurality of two-dimensional data points from the numbers of nodes and the numbers of edges, with each data point representing one ego network and the number of nodes of the ego network forming an x-coordinate of the data point and the number of edges of the ego network forming a y-coordinate of the data point; and
developing, using a computer learning system, a linear mathematical function defining a normal relationship between edges and nodes for each ego network, wherein developing the linear mathematical function comprises applying linear regression to the data points;
determining a distance of each data point from the linear mathematical function defining a normal relationship between edges and nodes for each ego network;
determining whether the distance of each data point is greater than a threshold; and
reporting the individuals associated with the data points whose distance is greater than the threshold to facilitate identifying the outliers, wherein reporting the individuals associated with the data points whose distance is greater than the threshold comprises displaying, on a display device, names or ID numbers associated with the individuals associated with the data points whose distance is greater than the threshold.

9. The computer-implemented method of claim 8, wherein determining the number of nodes for each ego network includes counting each contact as one node.

10. The computer-implemented method of claim 8, wherein determining the number of edges for each ego network includes counting each relationship between the individual and one contact as one edge and each relationship between two contacts as one edge.

11. (canceled)

12. A computer-implemented method for detecting outliers, the method comprising the following steps, wherein each step is performed by a processor of a computing device:
determining and/or receiving a list of individuals;
determining and/or receiving a list of contacts for each individual;
determining and/or receiving information listing relationships between the contacts and/or the individuals;
forming or generating a plurality of ego networks, one ego network formed for each individual with each ego network including a central hub representing the individual, a plurality of nodes with each node representing a contact, and a plurality of edges with each edge representing a relationship between one contact and the individual or between two contacts;
determining a number of nodes for each ego network;
determining a number of edges for each ego network;
forming a plurality of two-dimensional data points from the numbers of nodes and the numbers of edges, with each data point representing one ego network and the number of nodes of the ego network forming an x-coordinate of the data point and the number of edges of the ego network forming a y-coordinate of the data point;
developing, using a computer learning system, a mathematical function defining a normal relationship between edges and nodes for each ego network, wherein developing the mathematical function comprises applying curve fitting to the data points;
determining a distance of each data point from the the mathematical function defining a normal relationship between edges and nodes for each ego network to facilitate identifying the outliers; and
displaying, on a display device, names or ID numbers of the outliers.

13. The method of claim 12, wherein the individuals are associated with insurance products or services or financial products or services.

14. The method of claim 12, wherein the individuals are associated with filing insurance claims and an abnormal distance calculated for a data point is indicative of insurance claim fraud.

15. The method of claim 12, wherein the individuals are medical services providers that submit insurance claims on behalf of patients.

16. The method of claim 12, wherein the individuals are construction workers or companies that repair damaged insured homes.
